(19) United States
(12) Patent Application Publication
(10) Pub. No.: US 2011/0125731 A1
(43) Pub. Date: May 26, 2011

(54) INFORMATION PROCESSING APPARATUS, INFORMATION PROCESSING METHOD, PROGRAM, AND INFORMATION PROCESSING SYSTEM

(75) Inventor: Masaaki Isozu, Tokyo (JP)

(73) Assignee: Sony Corporation, Tokyo (JP)

(21) Appl. No.: 12/945,987

(22) Filed: Nov. 15, 2010

(30) Foreign Application Priority Data
Nov. 20, 2009 (JP) 2009-264819

(51) Int. Cl. G06F 17/30

(52) U.S. Cl. 707/722; 707/769; 707/E17.014

(57) ABSTRACT

There is provided an information processing apparatus including a structure analysis section that analyzes display control data in which information related to display control is written and which includes a plurality of structural units, and that extracts the structural unit included in the display control data, a layout setting section that sets layout information which is used when displaying the display control data on a display screen based on the structural unit extracted by the structure analysis section, a keyword extraction section that extracts a keyword from a display content corresponding to the structural unit, and a content search section that searches image content corresponding to the keyword extracted by the keyword extraction section. The layout setting section places the image content searched by the content search section in a display region, in which the structural unit including the keyword corresponding to the image content is displayed.

### BACKGROUND OF THE INVENTION

1. Field of the Invention

The present invention relates to an information processing apparatus, an information processing method, a program, and an information processing system.

2. Description of the Related Art

With the widespread of video sites, it has become possible to easily search video content only by entering a keyword, and it has become general to view video content on the Internet. Accordingly, there are proposed methods involving extracting a keyword from video content and acquiring content related to the extracted keyword (for example, see JP-A-2009-10797 and JP-A-2009-157460).

Further, it has become easy to embed video content into websites, blogs, and the like, and it has become easier for a user to find the video content that the user is interested in while viewing a website.

### SUMMARY OF THE INVENTION

There is also a case where, however, a user tries to find image content related to information written on a website in which image content such as video content is not embedded. In that case, it was necessary that the user extract a keyword that may be related to the image content from the written information by manual operation, and detect the related image content by using a search engine. Consequently, a method is desired, which is capable of automatically extracting a keyword and highly accurately searching the image content demanded by the user.

Further, even when a keyword is extracted from a certain website and corresponding image content is detected, in the case where, for example, the number of the extracted keywords is two or more, it was difficult to comprehend which of the keywords the image content obtained as a search result relates to.

In light of the foregoing, it is desirable to provide a novel and improved information processing apparatus, information processing method, program and information processing system, which are capable of displaying image content in such a manner that the correspondence relationship between the image content obtained as a search result and the keyword used for searching the image content is clearly shown.

According to an embodiment of the present invention, there is provided an information processing apparatus which includes a structure analysis section that analyzes display control data in which information related to display control is written and which includes a plurality of structural units, and that extracts the structural unit included in the display control data, a layout setting section that sets layout information which is used when displaying the display control data on a display screen based on the structural unit extracted by the structure analysis section, a keyword extraction section that extracts a keyword from a display content corresponding to the structural unit, and a content search section that searches image content corresponding to the keyword extracted by the keyword extraction section. The layout setting section places the image content searched by the content search section in a display region, in which the structural unit including the keyword corresponding to the image content is displayed.

The information processing apparatus may further include a selected subject determination section that determines a display content included in a selected region on a display screen which is selected by user operation. The layout setting section may generate position information, as the layout information, that includes coordinates indicating a position at which a display content corresponding to each structural unit is displayed on the display screen. The selected subject determination section may refer to the position information generated by the layout setting section, and, when at least a part of a region in which the display content corresponding to the structural unit is included in the selected region, may determine that the structural unit is selected.

The layout setting section may set a placement position of the image content within the display region by using coordinates indicating a position within the display screen based on the generated position information.

The layout setting section may additionally write, in a corresponding structural unit, information related to the image content and information indicating a placement position of the image content within the display region.

The keyword extraction section may analyze a type of the structural unit from which a keyword is extracted based on a type of a tag included in the structural unit, and, when the tag is a tag which defines a predetermined structure in the display screen, may extract at least one keyword from the structural unit including the tag.

According to another embodiment of the present invention, there is provided an information processing method which includes the steps of analyzing display control data in which information related to display control is written and which includes a plurality of structural units, and extracting the structural unit included in the display control data, setting layout information which is used when displaying the display control data on a display screen based on the structural unit, extracting a keyword from a display content corresponding to the structural unit, searching image content corresponding to the extracted keyword, and placing the searched image content in a display region, in which the structural unit including the keyword corresponding to the image content is displayed.

According to another embodiment of the present invention, there is provided a program for causing a computer to realize a structure analysis function that analyzes display control data in which information related to display control is written and which includes a plurality of structural units, and that extracts the structural unit included in the display control data, a layout setting function that sets layout information which is used when displaying the display control data on a display screen based on the structural unit extracted by the structure analysis function, a keyword extraction function that extracts a keyword from a display content corresponding to the structural unit, a content search function that searches image content corresponding to the keyword extracted by the keyword extraction function, and an image content placement function that places the image content searched by the content search function in a display region, in which the structural unit including the keyword corresponding to the image content is displayed.

According to another embodiment of the present invention, there is provided an information processing system including an information processing apparatus which includes a structure analysis section that analyzes display control data in which information related to display control is written and which includes a plurality of structural units, and that extracts the structural unit included in the display control data, and a layout setting section that sets layout information which is used when displaying the display control data on a display screen based on the structural unit extracted by the structure analysis section; and a content management server which includes a keyword extraction section that extracts a keyword from a display content corresponding to the extracted structural unit based on a extraction result of the structural unit transmitted from the information processing apparatus, and a content search section that searches image content corresponding to the keyword extracted by the keyword extraction section. The layout setting section places the image content searched by the content management server in a display region, in which the structural unit including the keyword corresponding to the image content is displayed.

According to the embodiments of the present invention described above, image content obtained as a search result is placed in a display region including a keyword corresponding to image content, and hence, the correspondence relationship between the image content obtained as a search result and the keyword used for searching the image content obtained as a search result becomes clear. As a result, according the embodiments of the present invention, the convenience of the user can be enhanced.

### BRIEF DESCRIPTION OF THE DRAWINGS

FIG. 1 is an explanatory diagram illustrating an information processing system according to a first embodiment of the present invention;

FIG. 2 is a block diagram illustrating a configuration of an information processing apparatus according to the embodiment;

FIG. 3A is an explanatory diagram illustrating the information processing apparatus according to the embodiment;

FIG. 3B is an explanatory diagram illustrating the information processing apparatus according to the embodiment;

FIG. 4 is an explanatory diagram illustrating the information processing apparatus according to the embodiment;

FIG. 5 is an explanatory diagram illustrating the information processing apparatus according to the embodiment;

FIG. 6 is an explanatory diagram illustrating the information processing apparatus according to the embodiment;

FIG. 7A is an explanatory diagram illustrating the information processing apparatus according to the embodiment;

FIG. 7B is an explanatory diagram illustrating the information processing apparatus according to the embodiment;

FIG. 8 is an explanatory diagram illustrating the information processing apparatus according to the embodiment;

FIG. 9 is an explanatory diagram illustrating the information processing apparatus according to the embodiment;

FIG. 10A is an explanatory diagram illustrating the information processing apparatus according to the embodiment;

FIG. 10B is an explanatory diagram illustrating the information processing apparatus according to the embodiment;

FIG. 11A is an explanatory diagram illustrating the information processing apparatus according to the embodiment;

FIG. 11B is an explanatory diagram illustrating the information processing apparatus according to the embodiment;

FIG. 12A is an explanatory diagram illustrating the information processing apparatus according to the embodiment;

FIG. 12B is an explanatory diagram illustrating the information processing apparatus according to the embodiment;

FIG. 13 is a flowchart illustrating an information processing method according to the embodiment;

FIG. 14 is a flowchart illustrating the information processing method according to the embodiment;

FIG. 15 is a flowchart illustrating the information processing method according to the embodiment;

FIG. 16 is a flowchart illustrating the information processing method according to the embodiment;

FIG. 17 is a flowchart illustrating the information processing method according to the embodiment;

FIG. 18 is an explanatory diagram illustrating a first modified example of the information processing method according to the embodiment; and

FIG. 19 is a block diagram illustrating a hardware configuration of the information processing apparatus according to an embodiment of the present invention.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

### (1) First Embodiment

(1-1) Information Processing System

(1-2) Configuration of Information Processing Apparatus

(1-3) Example of Display Screen

(1-4) Information Processing Method

(1-5) Modified Example

### (2) Hardware Configuration of Information Processing Apparatus According to Embodiment of the Present Invention

### (3) Summary

### First Embodiment

### Information Processing System

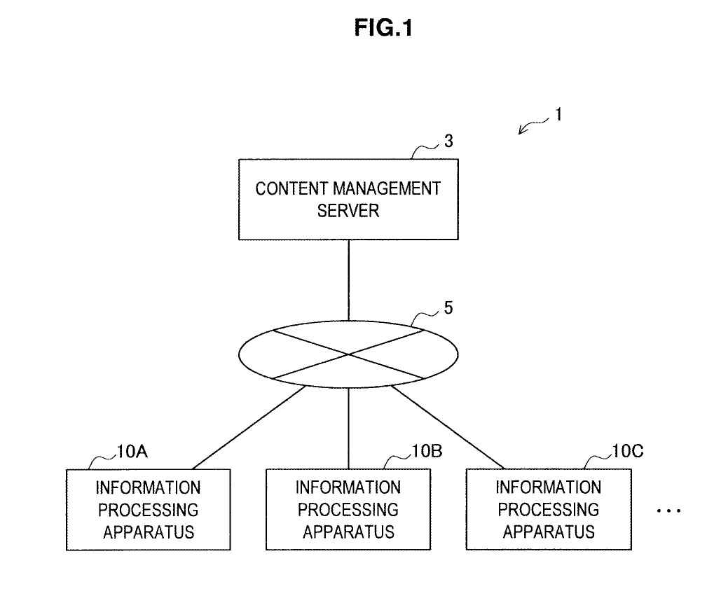

First, with reference to FIG. 1, an information processing system according to a first embodiment of the present invention will be described in detail. FIG. 1 is an explanatory diagram illustrating the information processing system according to the present embodiment.

An information processing system 1 according to the present embodiment include, as shown in FIG. 1 for example, a content management server 3 and information processing apparatuses 10A, 10B, 10C, and so on (hereinafter, simply abbreviated as information processing apparatus 10). The content management server 3 and the information processing apparatus 10 is connected to a communication network 5 as shown in FIG. 1. The content management server 3 and the information processing apparatus 10 can transmit/receive various types of information to/from each other via the communication network 5.

The content management server 3 is a server which manages: pieces of image content including video content such as motion picture content and still image content such as photo content; and various types of information associated with the pieces of image content. The content management server 3 provides the content itself that the content management server 3 manages, metadata of the content, and the like to the information processing apparatus 10 in response to a request from the information processing apparatus 10.

The communication network 5 is a communication line network which connects the content management server 3 with the information processing apparatus 10 and allows two-way communication therebetween. The communication network includes, for example, a public line network such as the Internet, a telephone line network, a satellite communication network, and a broadcast communication channel, and a leased line network such as a WAN (Wide Area Network), a LAN (Local Area Network), an IP-VPN (Internet Protocol-Virtual Private Network), an Ethernet (registered trademark), and a wireless LAN, and may be wired or wireless. That is, a content viewing system 1 according to the present embodiment may be a part of a public service using a public line network such as the Internet, or may be a private system which is not disclosed to a third party who utilizes a home network such as a LAN.

The information processing apparatus 10 is an apparatus which is communicable with the content management server 3 via the communication network 5. Further, the information processing apparatus 10 acquires various types of data from various servers (not shown) connected to the communication network 5, and can allow a user to view a website managed by the various servers. Further, the information processing apparatus 10 requests the content management server 3 connected to the communication network 5 to disclose image content and various types of information related to the image content, and acquires content and various types of information from the content management server 3. In this case, as will be described below, the information processing apparatus 10 is capable of automatically extracting a keyword from a description written on a website, and searching and acquiring image content related to the extracted keyword.

The information processing apparatus 10 may be any as long as it is a device having a communication function using a network, and examples of the device include various types of computer devices, television receivers, DVD/HDD/Blu-ray recorders, mobile phones, PDA's, and digital cameras. Further, the information processing apparatus 10 may also be a home information appliance such as a home video game machine or a digital video camera, a television broadcast tuner or decoder, or the like. Further, the information processing apparatus 10 may also be a portable device such as a portable game machine, a PHS, a portable video/audio player or the like.

Further, although the information processing apparatus 10 is connected to the content management server 3 via the communication network 5 in FIG. 1, the information processing apparatus 10 may be directly connected to the content management server 3 not via the communication network 5.

Further, although the number of the content management servers 3 connected to the communication network 5 is one in FIG. 1, the present embodiment is not limited to the case described above, and two or more content management servers 3 may be connected to the communication network 5. In the same manner, although the number of the information processing apparatuses 10 connected to the communication network 5 is three in FIG. 1, the present embodiment is not limited to the case described above, and the number of the information processing apparatuses 10 connected to the communication network 5 may be one, or four or more.

### <Configuration of Information Processing Apparatus>

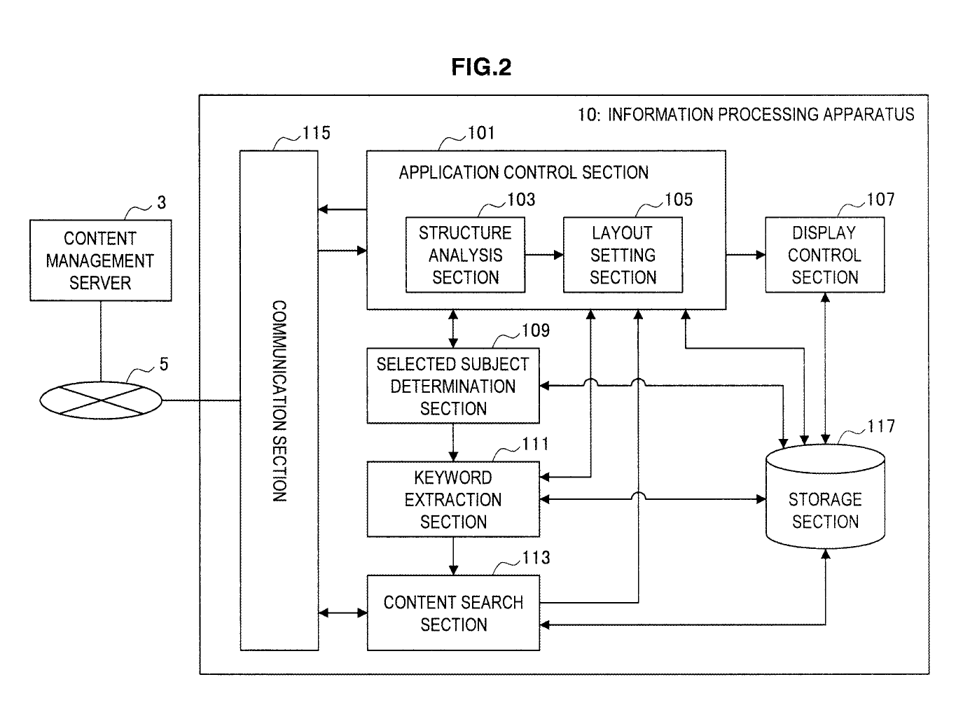

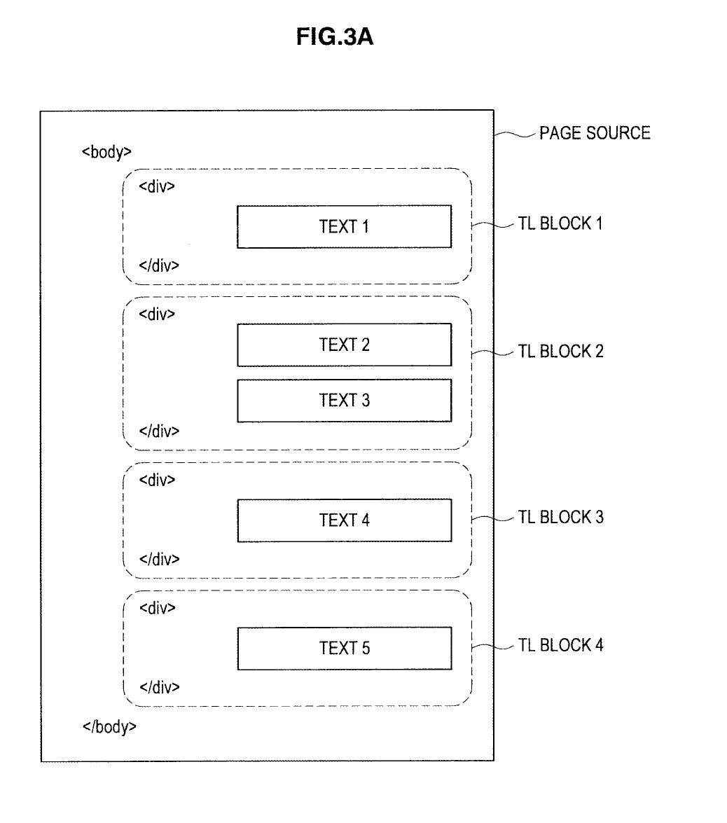

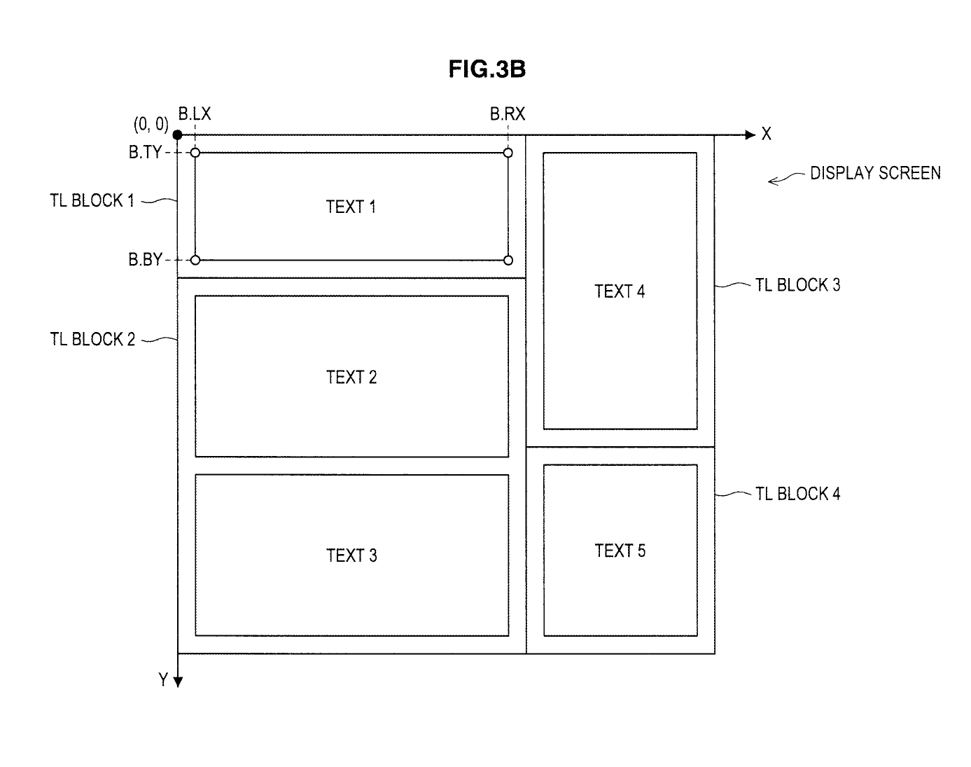

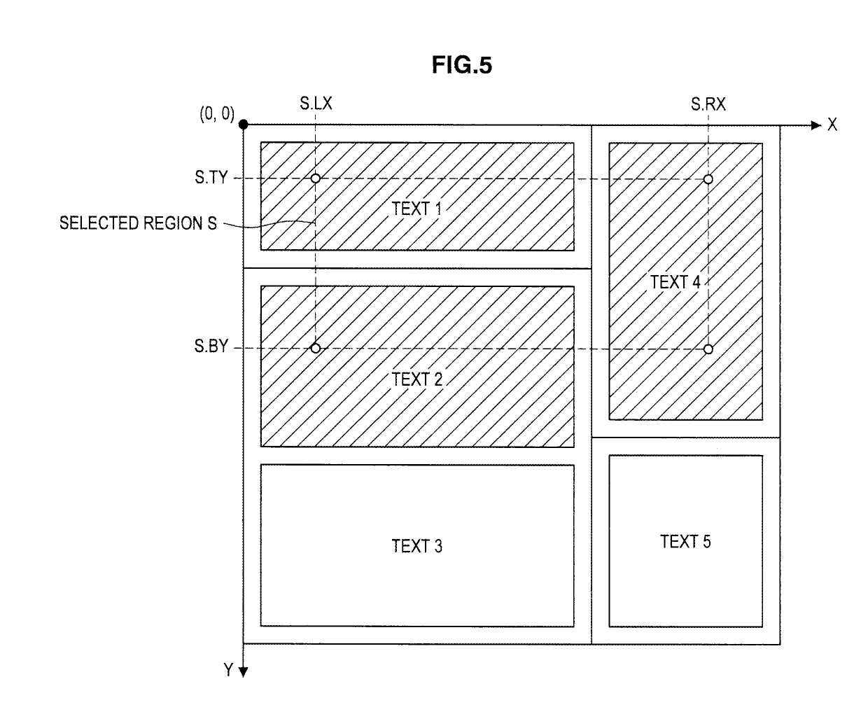

Subsequently, with reference to FIGS. 2 to 12B, a configuration of an information processing apparatus according to the present embodiment will be described in detail. FIG. 2 is a block diagram illustrating a configuration of the information processing apparatus according to the present embodiment. Further, FIGS. 3A to 12B are each an explanatory diagram illustrating the information processing apparatus according to the present embodiment.

Note that, description will be made below by taking as an example HTML data which defines contents of a web page, as an example of “display control data in which information related to display control is written and which includes multiple structural units”. However, the display control data according to the embodiment of the present invention is not limited thereto.

The information processing apparatus 10 according to the present embodiment mainly includes, as shown in FIG. 2 for example, an application control section 101, a display control section 107, a selected subject determination section 109, a keyword extraction section 111, a content search section 113, a communication section 115, and a storage section 117.

The application control section 101 is realized by, for example, a CPU (Central Processing Unit), a ROM (Read Only Memory), and a RAM (Random Access Memory). The application control section 101 is a control section which controls an application such as a web browser that causes a display section (not shown) of the information processing apparatus 10 to display contents of HTML data.

The application control section 101 requests a server (web server), which manages HTML data, for HTML data via the communication section 115 to be described later, and acquires the HTML data transmitted from the server in response to the request. The acquired HTML data is processed by a structure analysis section 103 and a layout setting section 105 which are included in the application control section 101, and is displayed on the display section (not shown) via the display control section 107 to be described later.

The structure analysis section 103 included in the application control section 101 is realized by a CPU, a ROM, and a RAM, for example. The structure analysis section 103 is a processing section which analyzes the HTML data acquired by the application control section 101 from a web server.

At this time, the structure analysis section 103 analyzes the structure of the HTML by using a parser program called HTML parser. As has been described, the HTML data is written by using specific tags that define the structural units. Accordingly, by using the parser program, a structural unit delimited by the tags can be extracted, or the relationship between the structural units can be analyzed. The structure analysis section 103 can analyze the HTML data, and can request a web server for an external resource where appropriate. The external resource here is, for example, a style sheet file that defines layout information and a script file that defines script information.

When the external resource as mentioned above is transmitted from the web server in response to the request, the application control section 101 acquires the external resource transmitted by the web server. When the acquired external resource is a CSS file, the application control section 101 applies the CSS. Also, when the acquired external resource is a script file, the application control section 101 performs script processing by a script engine.

After these processes have been performed by the application control section 101, the structure analysis section 103 builds a DOM (Document Object Model) by using information on the structural unit obtained as a result of the analysis.

The DOM is a tree structure built by linking the structural units of the HTML data extracted by the HTML parser. More properly, the DOM 12 is an API (Application Program Interface) for handling the structure or the contents of an HTML (or an XML). For example, let us assume that multiple structural units for defining the display configuration of a web page are included in the HTML data. These structural units are extracted in an analysis process by the structure analysis section 103, and are mutually linked and built into the form of the DOM.

Note that the tree structure of the DOM is a conceptual expression of a structure recognized by the web browser. A web page that is actually viewed by a user is created by a rendering engine of an application such as the web browser based on the tree structure of the DOM. The process of displaying a web page is complete when, after the structure analysis section 103 has built the DOM, the layout setting section 105 to be described later has adjusted a display layout based on the tree structure of the DOM, and has embedded content such as image data and text data into a specific location in the display layout.

Here, the structure analysis section 103 according to the present embodiment performs an analysis process by focusing on a keyword which defines, as one set of information, the information placed between tags such as a “div” tag as shown in FIG. 3A and a “span” tag.

For example, in the example shown in FIG. 3A, “TEXT 1” placed between <div> and </div> is treated as one block. The block represents, as shown in FIG. 3B for example, a range in terms of data that defines one large region (partial region) on a display screen. In the present embodiment, the partial region defined by specific tags as described above will be referred to as top-level block (TL block).

Further, the structure analysis section 103 performs an analysis by focusing on a more detailed block included in the top-level block, and determines presence or absence of a child block which is included in a top-level block as a parent block. For example, the structure analysis section 103 can analyze the HTML data shown in FIG. 3A, and can recognize that four TL blocks are present in the HTML data. Further, the structure analysis section 103 can also recognize that only one child block is present in each of TL blocks 1, 3, and 4, and that two child blocks are present in a TL block 2. In this way, the structure analysis section 103 determines presence or absence of a block (document block) that indicates display contents included in the HTML data.

The structure analysis section 103 outputs information related to the structural unit (in particular, document block) obtained as a result of the analysis of the HTML data to the layout setting section 105. Further, the information related to the structural unit is also output to the selected subject determination section 109 to be described later.

The layout setting section 105 is realized by, for example, a CPU, a ROM, and a RAM. The layout setting section 105 uses the analysis result of the analysis process of the HTML data performed by the structure analysis section 103, and sets a layout at the time of displaying the contents corresponding to the HTML data on the display screen. The layout is adjusted, as described above, based on the tree structure of the DOM, and the layout setting section 105 generates layout information related to a decided layout. The application control section 101 executes the HTML data based on the layout information generated by the layout setting section 105 and requests the display control section 107 to control a display section, and hence, a web page corresponding to the HTML data is displayed on a display screen.

When a position where each block which forms the display screen is identified at the time of setting the layout of the HTML data, the layout setting section 105 generates information indicating the position as position information. For example, in the case where the layout at the time of the HTML data having a structure shown in FIG. 3A is displayed on the display screen is determined as the layout shown in FIG. 3B, the layout setting section 105 specifies the positions of four corners of each of the blocks displayed on the display screen, and generates information indicating the four corners as position information.

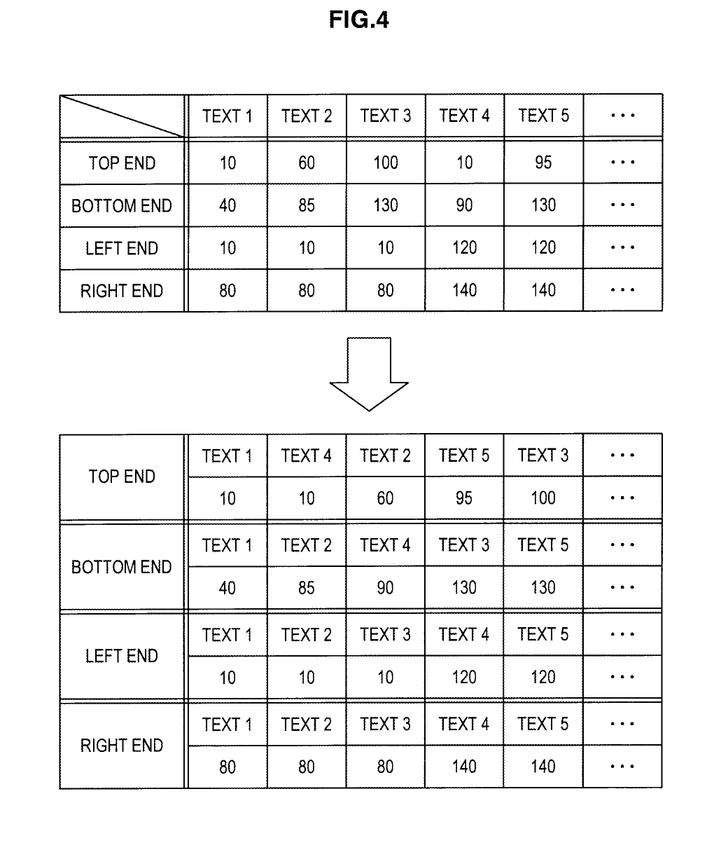

The positions of four corners of a block represent a display position of the block in an application controlled by the application control section 101. The display position may be different depending on information processing apparatuses 10, and further, depending on applications. Therefore, the display position is peculiar to an execution environment of HTML data. Specifically, as shown in FIG. 3B, there is considered a coordinate system having any one point (e.g., the top-left endpoint of the display screen) as the origin of the coordinate axes, and the layout setting section 105 records the coordinates indicating the position of the four corners as position information. As a result, a table shown in the upper side of FIG. 4 is generated as the position information related to the layout shown in FIG. 3B, for example. The table shown in the upper side of FIG. 4 includes information (coordinates of top end, bottom end, left end, right end) indicating the positions of the four corners of each of the blocks (TEXT 1 to TEXT 5). For example, the top end of the “TEXT 1” block shown in FIG. 3B corresponds to B.TY in FIG. 3B, and the bottom end corresponds to B.BY in FIG. 3B. Further, the left end of the “TEXT 1” block shown in FIG. 3B corresponds to B.LX in FIG. 3B, and the right end corresponds to B.RX in FIG. 3B.

Further, the layout setting section 105 may sort the position information as shown in the upper side of FIG. 4 by focusing on a position (top end, bottom end, or the like), to thereby obtain new position information as shown in the lower side of FIG. 4. The position information shown in the lower side of FIG. 4 indicates the order of display contents each corresponding to a block appear in the case where the display screen is seen in a particular direction. For example, in the case of focusing on the line of “TOP END”, it is indicated that when the display screen is seen from the top to the bottom, the blocks of TEXT 1 and TEXT 4 appear at the same height (e.g., same Y-coordinate value in FIG. 3B), and subsequently, the blocks of TEXT 2, TEXT 5, and TEXT 3 appear.

When the position information as shown in the lower side of FIG. 4 is generated, it becomes possible for a processing section such as the selected subject determination section 109 to be described later to easily comprehend a relative position relationship of respective blocks on the display screen.

Heretofore, the application control section 101 according to the present embodiment has been described in detail.

Next, the display control section 107 according to the present embodiment will be described in detail.

The display control section 107 is realized by, for example, a CPU, a ROM, and a RAM. The display control section 107 is a processing section which performs display control of a display section (not shown) included in the information processing apparatus 10 according to the present embodiment. The display control section 107 causes the display section to display a web page corresponding to HTML data in response to a request the display control section 107 is notified of by the application control section 101.

The selected subject determination section 109 is realized by, for example, a CPU, a ROM, and a RAM. When a part of a web page displayed on the display screen is selected by user operation, the selected subject determination section 109 determines which document block is selected from the contents of the web page. Specifically, when the region on the display screen selected by the user operation (hereinafter, referred to as selected region S) is decided, the selected subject determination section 109 specifies information indicating the positions of the four corners of the selected region S. Subsequently, the selected subject determination section 109 determines whether or not a document block at least a part of which is included within the selected region S is present, by using the information indicating the positions of the four corners of the selected region S and the position information generated by the layout setting section 105. In the case where a document block at least a part of which is included within the selected region S is present, the selected subject determination section 109 determines the document block as a selected block, and determines that the contents written in the selected block as selected contents selected by the user operation.

There is considered a case where there is a web page having a layout shown in FIG. 3B which is defined by the HTML data exemplified in FIG. 3A, and a user attempts to select the document blocks of TEXT 1, TEXT 2, and TEXT 4. When a method in the past is used, there was an issue that four document blocks of TEXT 1 to TEXT 4 were selected, even though a user performed a drag-and-drop operation from near the top of TEXT 1 to near the bottom of TEXT 4 in an attempt to select TEXT 1, TEXT 3, and TEXT 4. This occurs because, as shown in a TL block2 in FIG. 3A, multiple document blocks are present in one TL block. Such an issue also occurs in the case where the user attempts to select the document blocks of TEXT 3 and TEXT 5 which are each shown in FIG. 3B, for example.

However, the selected subject determination section 109 according to the present embodiment can appropriately select only the document block that the user intends to select, by using both the information indicating a display position of each document block and the information indicating a position of the selected region S. Note that the determination process of the selected subject will be described below in detail again.

The selected subject determination section 109 notifies the keyword extraction section 111 to be described later of the information of the thus determined document block corresponding to the selected subject.

The keyword extraction section 111 is realized by, for example, a CPU, a ROM, and a RAM. The keyword extraction section 111 uses the information of the selected document block notified from the selected subject determination section 109 and the contents (data) of the corresponding document block acquired from the application control section 101, and extracts a keyword from the words written in the document block. Here, any appropriate method is utilizable as a method used for the keyword extraction section 111 to extract a keyword, and a technique such as morphological analysis can be used, for example. In addition, a type of keyword to be extracted can be appropriately set by using information which defines extraction conditions and the like that are set by the user beforehand.

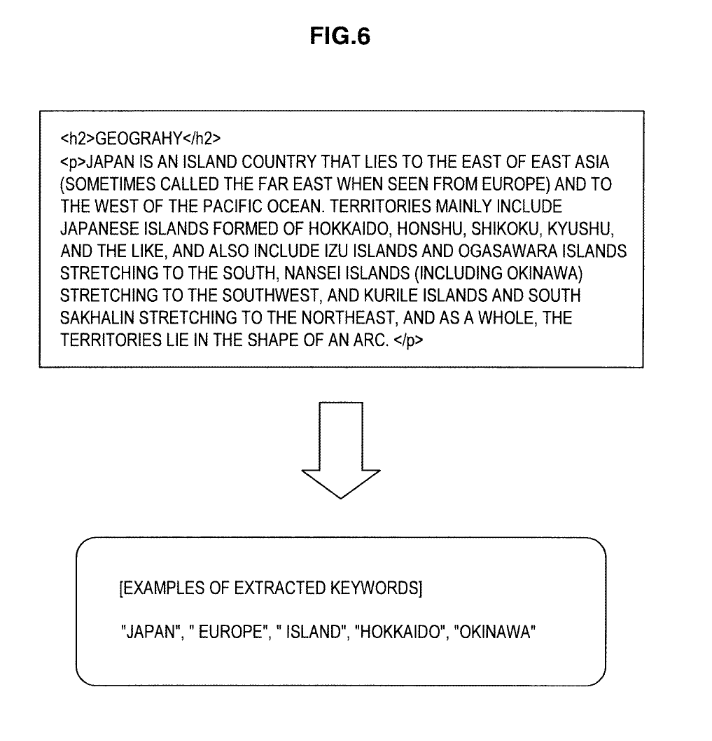

When extracting a keyword from the document block, the keyword extraction section 111 determines a range from which a keyword is extracted by focusing on the structure of the document block. For example, as shown in the upper side of FIG. 6, in the case where a tag for defining a specific structure in the document block is absent, the keyword extraction section 111 freely extracts a keyword from the writing in the document block. For example, in the case where there is the writing such as the one shown in the upper side of FIG. 6, the keyword extraction section 111 extracts keywords such as “Japan”, “Europe”, “Island”, “Hokkaido”, and “Okinawa”. As an example of HTML data in which a tag for defining a specific structure is absent, there is given a content of a web page such as a news site.

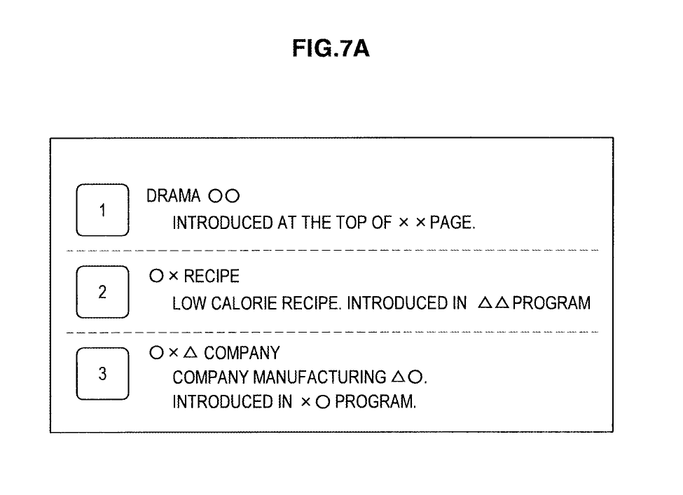

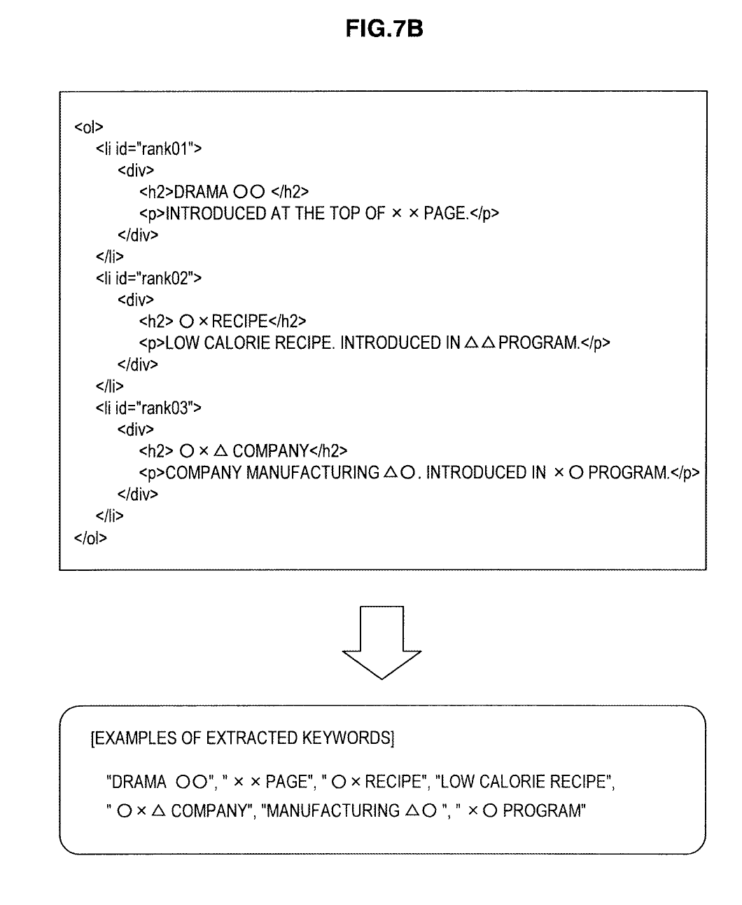

Further, there may also occur a case where a selected block is a block having a specific structure like the case of contents for displaying ranking information as shown in FIG. 7A. The document block includes tags that define a predetermined structure in the display screen, such as a <TABLE> tag, a <li> tag (list tag), and an <OL> tag shown in the upper side of FIG. 7B. Accordingly, in the case where the specific tags are written within the selected block, the keyword extraction section 111 extracts a keyword from each of the further smaller structural units defined by those tags.

For example, in the examples shown in FIGS. 7A and 7B, three small structural units defined by the <li> tags are built within the document block as a structure defining a ranking. Accordingly, the keyword extraction section 111 extracts a keyword from each of the further smaller structural units defined by respective <li> tags. By extracting keywords in this way, it can be prevented from performing extraction of keywords that places disproportionate weight within only one specific structure.

For example, in the example shown in FIGS. 7A and 7B, the keywords shown in the lower side of FIG. 7B are evenly extracted from each of structural units corresponding to a rank 1, a rank 2, and a rank 3, respectively.

The analysis of whether or not the selected block includes the tags that define a predetermined structure as described above can be performed by an HTML parser, for example. Accordingly, the keyword extraction section 111 may perform structure analysis of a selected block by using the HTML parser that the keyword extraction section 111 can execute, or may request the structure analysis section 103 of the application control section 101 to perform structure analysis of selected block.

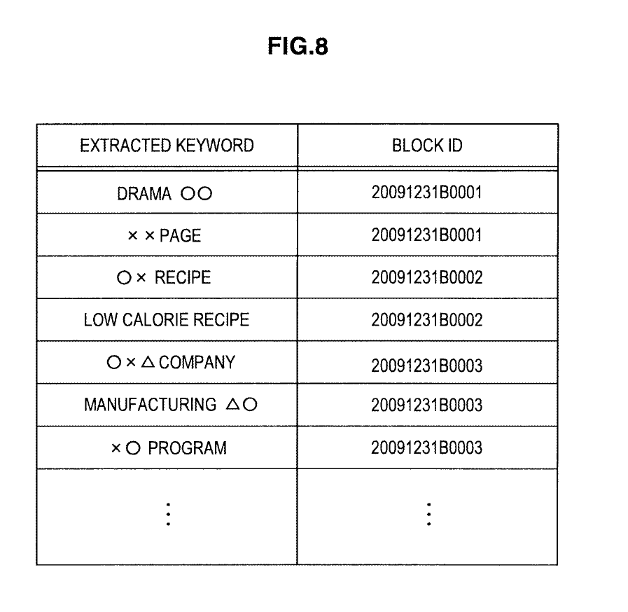

Note that, in the case where a specific tag is written within a selected block, it is important that the keyword extraction section 111 comprehends the correspondence relationship between the extracted keyword and the block in which the extracted keyword is written (block that is defined by a specific tag). Consequently, as shown in FIG. 8 for example, the keyword extraction section 111 generates data in which the extracted keyword and an ID for specifying the block in which the keyword is present are mutually associated with each other. In the case where the data is generated, the keyword extraction section 111 records the data indicating the correspondence relationship in the location that can be referred to by the application control section 101 such as the storage section 117 to be described later. Therefore, it becomes possible for the application control section 101 to display the keyword at an appropriate part, at the time of additionally displaying image content which will be described below on the display screen image content.

The keyword extraction section 111 notifies the content search section 113 to be described later of the keyword which is extracted by the method described above.

The content search section 113 is realized by, for example, a CPU, a ROM, and a RAM. The content search section 113 uses a keyword notified from the keyword extraction section 111 and searches image content (still image content, video content, and the like) related to the keyword. When detecting appropriate content, the content search section 113 acquires metadata corresponding to the detected image content from the content management server 3. The metadata includes, for example, information indicating a location of data itself of the detected image content, and a thumbnail image of the image content. The content search section 113 transmits the search result of content and the metadata including the acquired thumbnail image to the application control section 101.

When acquiring the search result of content and the metadata including the thumbnail image, the application control section 101 starts processing for displaying the search result on the display screen based on the acquired information.

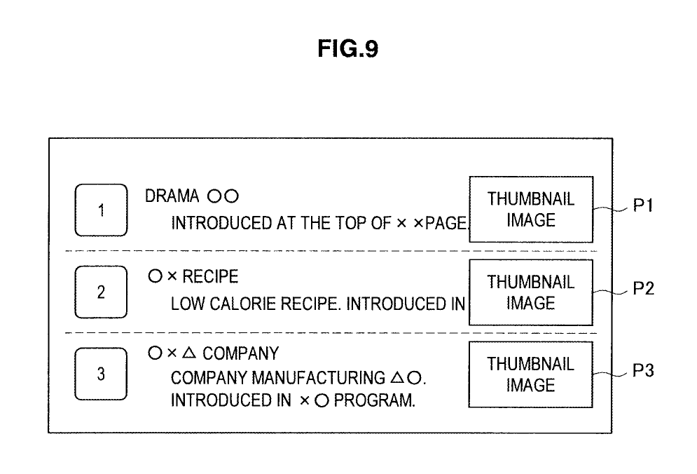

The layout setting section 105 of the application control section 101 performs resetting of the layout in a manner that a thumbnail image of the image content obtained as a search result is placed within the block in which the keyword corresponding to the image content is present. For example, in the example shown in FIG. 9, the resetting of the layout is performed in a manner that a thumbnail image P1 of the content corresponding to the keyword extracted from an article related to the rank 1 is placed within the block corresponding to the rank 1. In the same way, the resetting of the layout is performed in a manner that, within the block corresponding to the rank 2, a thumbnail image P2 of the corresponding content is placed, and within the block corresponding to the rank 3, a thumbnail image P3 of the corresponding content is placed.

Note that the thumbnail image to be displayed may be any as long as at least a part of the thumbnail image is present inside the corresponding block, so it can be clearly seen that which of the blocks the content is related to, and entire part of the thumbnail image does not have to be present inside the corresponding block.

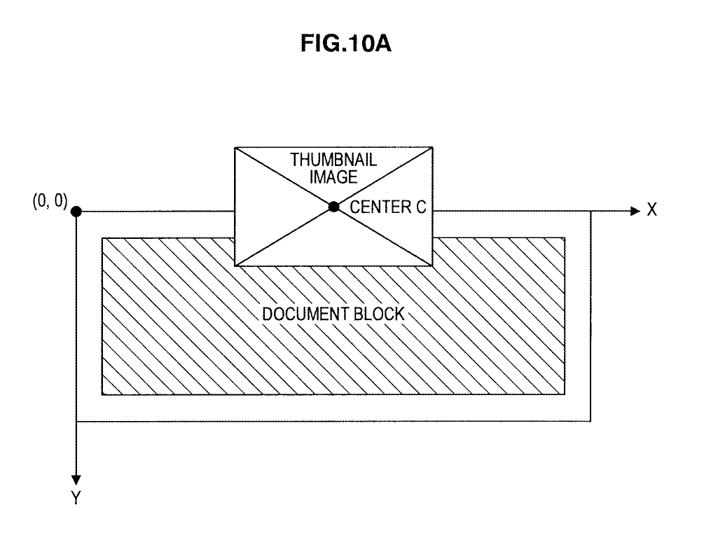

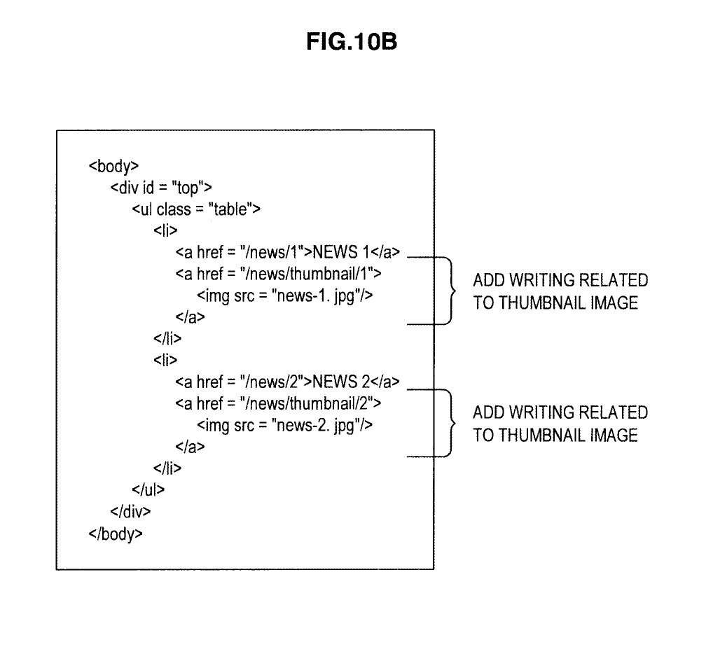

The layout setting section 105 can set the display position of the thumbnail image by using the position information shown in FIG. 4. That is, the layout setting section 105 may set the layout of the thumbnail image by referring to the position information of the document block in which the thumbnail image is to be displayed, and by assuming that the coordinates of an appropriate position within a display region of the document block is the center of the thumbnail image. In the example shown in FIG. 10A, the layout setting section 105 sets the coordinates of the center of the thumbnail image as follows: X=X-coordinate of the center of the document block; and Y=0. The layout setting section 105 can appropriately set the coordinates to be the center coordinates of the thumbnail image.

Further, the application control section 101 may rewrite the HTML data itself, and may display a search result on an appropriate block. In this case, the structure analysis section 103 determines the position of the corresponding keyword by using XPath, and inserts a structural unit using appropriate tags into the corresponding HTML data or DOM, for example. By referring to the HTML data into which a predetermined structural unit is inserted and the DOM regenerated based on the HTML data, the layout setting section 105 can reset a new layout.

For example, in the example shown in FIG. 10B, the structure analysis section 103 designates a <body> tag→>a <div> tag→>a <ul> tag→>a <li> tag, and embeds structural units (bold letters in the figure) which define a display position and the like of a thumbnail image corresponding to the search result into the HTML data.

At the time of placing the thumbnail image, the application control section 101 can freely select whether to designate the coordinates or to perform rewriting of the HTML data, depending on the structure of the web page, the structure of the corresponding block, the design of the web page, and the like.

Note that, although the structure analysis section 103 inserts the predetermined structural units into the HTML data in the example shown in FIG. 10B, the structure analysis section 103 can insert structural units also into an appropriate file and data such as a CSS file, in addition to the HTML data.

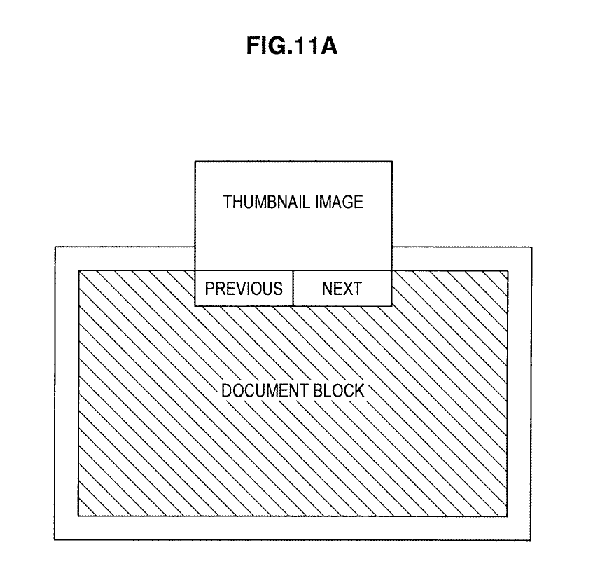

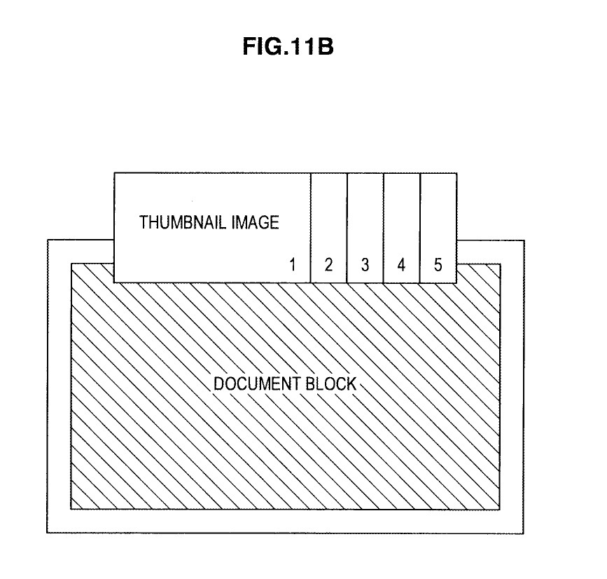

Further, there may also occur a case where multiple pieces of image content are searched with respect to one extracted keyword. In this case, as shown in FIG. 11A for example, the application control section 101 may display a thumbnail image together with operation buttons such as a “Previous” button and a “Next” button, in order for a user to select a thumbnail image from among multiple thumbnail images. Further, as shown in FIG. 11B, the application control section 101 may display, on the screen, multiple thumbnail images in a manner that each image is shifted a little from the image placed immediately thereon, and may allow a user to select a desired image. In addition, the application control section 101 may further select a thumbnail image to be displayed by using a priority order that is set beforehand, and information such as a search history and viewing history of the user.

By performing the display as described above, it becomes possible for a user to easily determine a block which includes display content that the searched content corresponds to. As a result, the information processing apparatus 10 according to the present embodiment can enhance the convenience of the user.

Subsequently, the communication section 115 will be described.

The communication section 115 is realized by, for example, a CPU, a ROM, a RAM, and a communication device. The communication section 115 is a processing section which controls communication performed between the information processing apparatus 10 according to the present embodiment and another device (for example, content management server 3 and other various servers) which is provided outside the information processing apparatus 10. The other device to be a communication partner may be a device which is connected to the information processing apparatus 10 via a local area network, or may be a device which is connected thereto via a public network such as the Internet. The communication control in the communication section 115 is performed based on a predetermined protocol which is set beforehand between the communication section 115 and the device to be a communication partner.

The storage section 117 is an example of a storage device that the information processing apparatus 10 according to the present embodiment has. In the storage section 117, there are stored as appropriate: various parameters, a record of processing in progress, and the like, which are necessarily stored at the time of the information processing apparatus 10 performing some processing; or various databases. Data can be freely written to or read from the storage section 117 by respective processing sections included in the information processing apparatus 10 according to the present embodiment.

Heretofore, an example of the function of the information processing apparatus 10 of the present embodiment has been shown. Each structural element described above may be configured by using a general-purpose material and circuit, or may be configured from a hardware dedicated to the function of each structural element. Further, the function of each structural unit may be entirely performed by a CPU and the like. Therefore, the configuration to be used can be appropriately changed depending on the technical level at the time of carrying out the present embodiment.

Note that it is possible to produce a computer program for realizing respective functions of the information processing apparatus of the present embodiment described above, and to implement the computer program to a personal computer and the like. Further, there can be also provided a computer-readable recording medium which stores the computer program. The recording medium includes, for example, a magnetic disk, an optical disk, a magneto-optical disk, and a flash memory. Further, the computer program may be distributed without using the recording medium, and may be distributed via a network, for example.

### <Example of Display Screen>

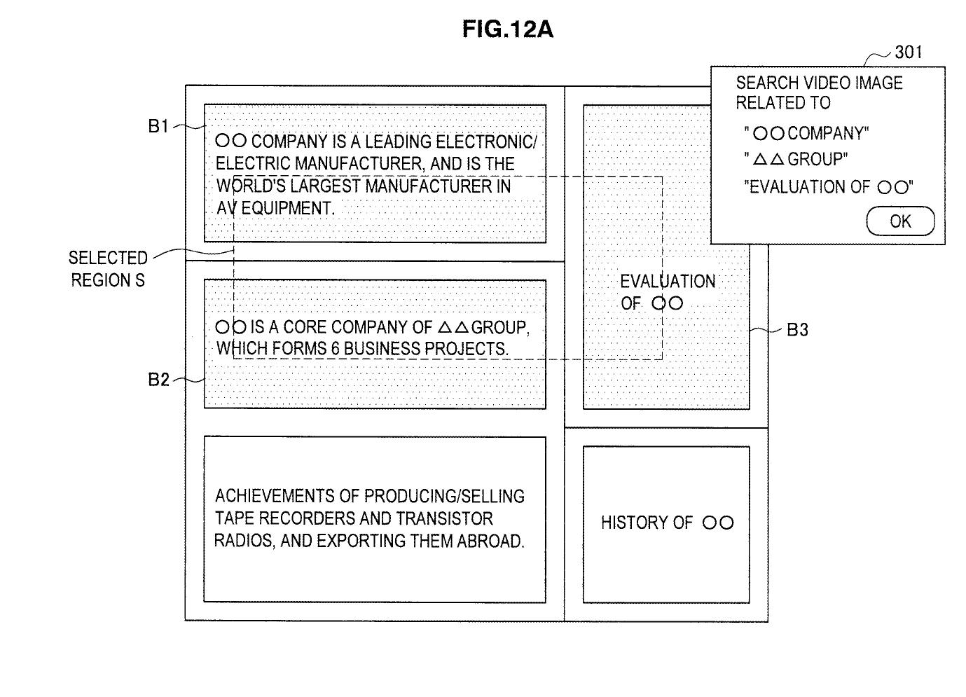

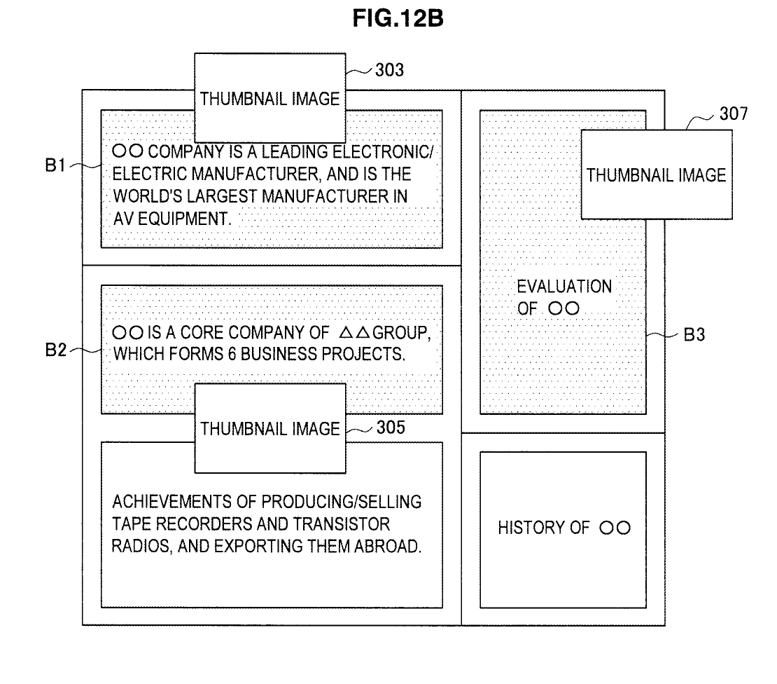

Subsequently, with reference to FIGS. 12A and 12B, an example of a display screen of the information processing apparatus 10 according to the present embodiment will be briefly described.

FIG. 12A shows an example in which the information processing apparatus 10 displays a web page designated by a user on the display screen by a web browser which is executed and controlled by the application control section 101. Here, it is assumed that the user operates an input device such as a mouse and designates a selected region S as shown in the figure. Then, the selected subject determination section 109 determines which are the selected blocks based on the selected region S and the position information of each document block, and specifies that blocks B1, B2, and B3 are selected. Subsequently, the keyword extraction section 111 extracts a keyword from each block, and notifies the user of the extracted keyword by displaying a dialogue box 301 on the display screen. When processing for requesting the start of the search of content by the user, the content search section 113 uses an appropriate keyword, and starts searching still image content, video content, and the like.

When appropriate content is specified as the result of the search, the content search section 113 transmits the search result and the acquired metadata to the application control section 101. The application control section 101 performs resetting of the layout based on the acquired information and causes the display section to display the display screen as shown in FIG. 12B. In this case, a thumbnail image 303 corresponding to the keyword extracted from the block B1 is placed in the vicinity of the block B1, and a thumbnail image 305 corresponding to the keyword extracted from the block B2 is placed in the vicinity of the block B2. Further, a thumbnail image 307 corresponding to the keyword extracted from the block B3 is placed in the vicinity of the block B3.

The information processing apparatus 10 according to the present embodiment forms and provides the display screen to the user, and hence can provide to the user image content which works in conjunction with the information written in the block. Thus, the information processing apparatus 10 according to the present embodiment can enhance the convenience of the user.

### <Information Processing Method>

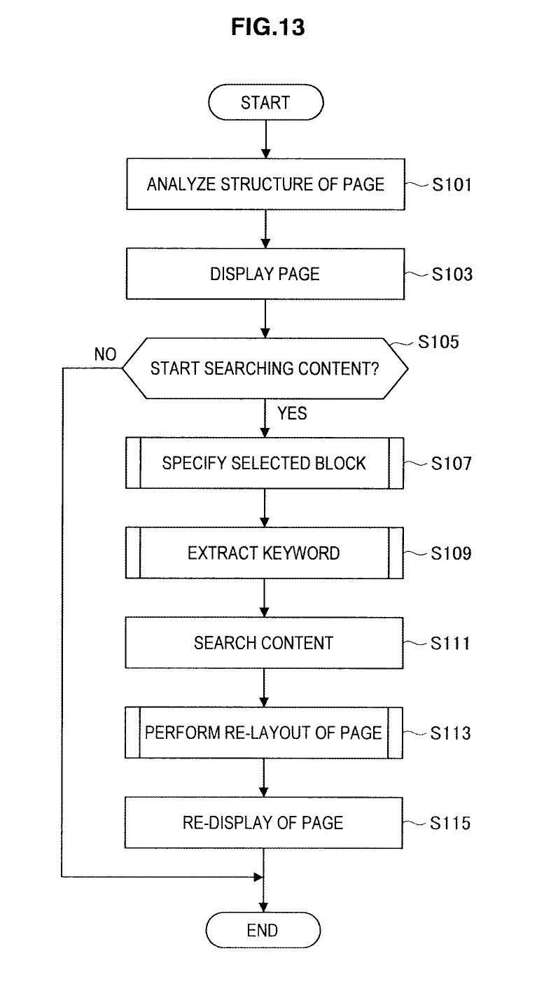

Next, with reference to FIGS. 13 to 17, an information processing method carried out by the information processing apparatus 10 according to the present embodiment will be described in detail. FIGS. 13 to 17 are each a flowchart illustrating the information processing method according to the present embodiment.

First, with reference to FIG. 13, an overall flow will be described.

The application control section 101 of the information processing apparatus 10 acquires, when a certain web page is designated by a user, display control data (HTML data) corresponding to the web page from a web server which manages the web page. After that, the structure analysis section 103 of the application control section 101 analyzes the acquired HTML data to thereby perform analysis of the structure of the web page (Step S101). The structure analysis section 103 builds a DOM by using the analysis result, and outputs the built DOM to the layout setting section 105. The layout setting section 105 performs setting of a page layout based on the input DOM, and displays the web page on the display section via the display control section 107 (Step S103).

Here, the information processing apparatus 10 waits while displaying the web page until operation of selecting a display content shown in the display screen is performed by the user, and determines whether to start content search processing (Step S105).

When the user operation is performed and the search processing of the content is to be started, the selected subject determination section 109 specifies a selected block by using position information of the selected region S selected by the user and position information generated by the layout setting section 105 (Step S107).

When a document block selected by the user is specified as the selected block by the selected subject determination section 109, the keyword extraction section 111 performs morphological analysis with respect to the contents written in the selected block and extracts a keyword (Step S109).

Subsequently, the content search section 113 searches, by using the keyword extracted by the keyword extraction section 111, image content related to the keyword from the content management server 3 (Step S111). When a search result is obtained, the content search section 113 outputs the obtained search result and metadata associated with the image content to the application control section 101.

When the application control section 101 is notified of the search result of content from the content search section 113, the application control section 101 performs re-layout of a page by using the notified information (Step S113). When the resetting of the page layout is performed, the display control section 107 re-displays a web page in which a thumbnail image is placed on the display section (Step S115).

In the information processing method according to the present embodiment, the thumbnail image of the image content corresponding to the keyword extracted from the display contents is displayed on the display screen by following the flow described above.

### [Selected Block Specification Processing]

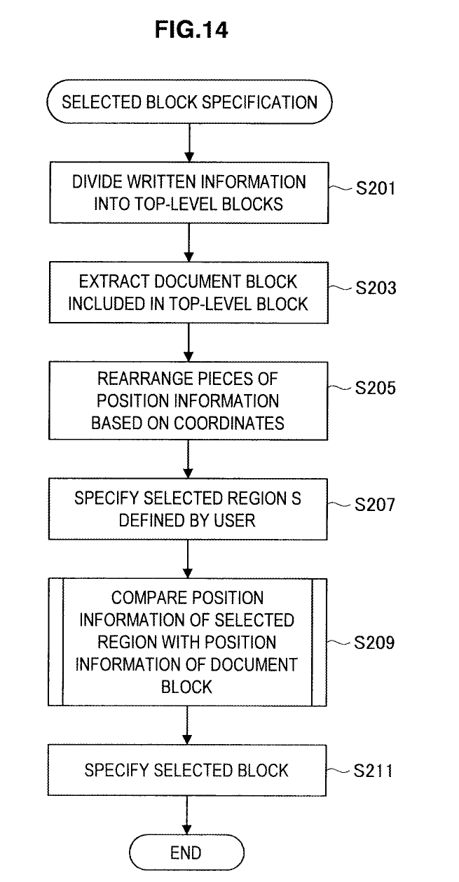

Next, with reference to FIG. 14, selected block specification processing, which is performed by the application control section 101 in cooperation with the selected subject determination section 109, will be described.

First, the structure analysis section 103 of the application control section 101 analyzes HTML data corresponding to a web page displayed on the display screen, and divides information included in the HTML data into top-level blocks (Step S201). Subsequently, the structure analysis section 103 analyzes a structure of each top-level block and extracts document blocks included in the top-level block (Step S203). Next, the layout setting section 105 of the application control section 101 specifies positions at which respective document blocks are to be displayed, generates pieces of position information indicating the display positions of the respective document blocks, and rearranges the pieces of position information based on coordinates (Step S205). By referring to the pieces of position information, it becomes possible for the application control section 101 and the selected subject determination section 109 to easily comprehend a relative position relationship of the respective document blocks.

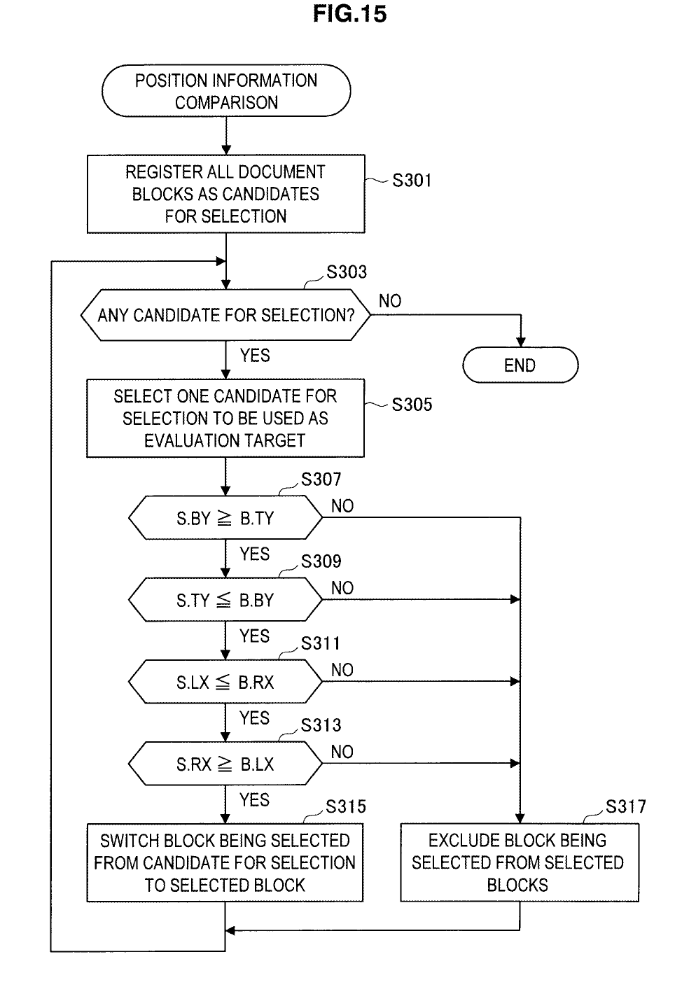

When a display content on the display screen is selected by the user, the selected subject determination section 109 specifies a range of the selected region S defined by the user operation (Step S207). Subsequently, the selected subject determination section 109 performs processing of comparing position information of the specified selected region S with position information of a document block (Step S209). By performing the comparison processing, the selected subject determination section 109 specifies the selected block selected by the user operation (Step S211). Note that the comparison processing will be described separately below with reference to FIG. 15.

### [Position Information Comparison Processing]

Subsequently, with reference to FIG. 15, position information comparison processing performed by the selected subject determination section 109 will be described.

First, the selected subject determination section 109 registers all document blocks present in a web page as candidates for selected blocks (hereinafter, each referred to as candidate for selection) (Step S301). Subsequently, the selected subject determination section 109 performs Step S303 which is described below.

In Step S303, it is determined whether or not a document block registered as a candidate for selection is present. In the case where the document block registered as a candidate for selection is not present (that is, in the case where the determination with respect to all document blocks is finished), the selected subject determination section 109 finishes the position information comparison processing. Further, in the case where the document block registered as a candidate for selection is present, the selected subject determination section 109 performs Step S305 which is described below.

In the case where any candidates for selection remain, the selected subject determination section 109 selects one candidate for selection to be used as a target of an evaluation which is carried out below (Step S305).

Subsequently, the selected subject determination section 109 determines whether a value of Y-coordinate (B.TY) of the top end of the candidate for selection serving as an evaluation target is equal to or less than a value of Y-coordinate (S.BY) of the bottom end of the selected region S selected by the user (Step S307). In the case where S.BY≧B.TY is not satisfied, the selected subject determination section 109 performs Step S317, which will be described below, with respect to the candidate for selection serving as an evaluation target. Further, in the case where S.BY≧B.TY is satisfied, the selected subject determination section 109 performs Step S309, which will be described below, with respect to the candidate for selection serving as an evaluation target.

Next, the selected subject determination section 109 determines whether a value of Y-coordinate (B.BY) of the bottom end of the candidate for selection serving as an evaluation target is equal to or more than a value of Y-coordinate (S.TY) of the top end of the selected region S selected by the user (Step S309). In the case where S.TY≦B.BY is not satisfied, the selected subject determination section 109 performs Step S317, which will be described below, with respect to the candidate for selection serving as an evaluation target. Further, in the case where S.TY≦B.BY is satisfied, the selected subject determination section 109 performs Step S311, which will be described below, with respect to the candidate for selection serving as an evaluation target.

Subsequently, the selected subject determination section 109 determines whether a value of X-coordinate (B.RX) of the right end of the candidate for selection serving as an evaluation target is equal to or more than a value of X-coordinate (S.LX) of the left end of the selected region S selected by the user (Step S311). In the case where S.LX≦B.RX is not satisfied, the selected subject determination section 109 performs Step S317, which will be described below, with respect to the candidate for selection serving as an evaluation target. Further, in the case where S.LX≦B.RX is satisfied, the selected subject determination section 109 performs Step S313, which will be described below, with respect to the candidate for selection serving as an evaluation target.

Next, the selected subject determination section 109 determines whether a value of X-coordinate (B.LX) of the left end of the candidate for selection serving as an evaluation target is equal to or less than a value of X-coordinate (S.RX) of the right end of the selected region S selected by the user (Step S313). In the case where S.RX≧B.LX is not satisfied, the selected subject determination section 109 performs Step S317, which will be described below, with respect to the candidate for selection serving as an evaluation target. Further, in the case where S.RX≧B.LX is satisfied, the selected subject determination section 109 performs Step S315, which will be described below, with respect to the candidate for selection serving as an evaluation target.

In the case where the determination condition of Step S313 is satisfied, the selected subject determination section 109 switches the candidate for selection serving as an evaluation target to a selected block selected by the user operation (Step S315). That is, when the candidate for selection is selected as the selected block, it means that four determination conditions of Step S307 to Step S313 are all satisfied. Further, when the four determination conditions are all satisfied, it means that, as is clear from the determination conditions, at least a part of the candidate for selection is included in the selected region S. Accordingly, one candidate for selection which has been served as an evaluation target is excluded from the candidates for selection. When the switching is finished, the selected subject determination section 109 returns to Step S303 and continues the processing.

On the other hand, in the case where any one of the conditions of Step S307 to Step S313 is not satisfied, the selected subject determination section 109 determines that the candidate for selection which has been served as an evaluation target is not the block selected by the user. The selected subject determination section 109 excludes such evaluation target from the candidates for selection (Step S317). Accordingly, one candidate for selection which has been served as an evaluation target is excluded from the candidates for selection. When the exclusion is finished, the selected subject determination section 109 returns to Step S303 and continues the processing.

As has been described above, in the selected block specification processing according to the present embodiment, the determination of whether a document block is a selected block is performed with respect to each document block by using position information of the document block. Therefore, even when the user performs the block selection that extends over several top-level blocks, there does not occur any more a case where the block that the user does not intend to select is selected, which has been the case in the past. Therefore, the selected block specification processing according to the present embodiment can provide an interface which enables the user to easily and comfortably select the document block that the user intends to select.

### [Keyword Extraction Processing]

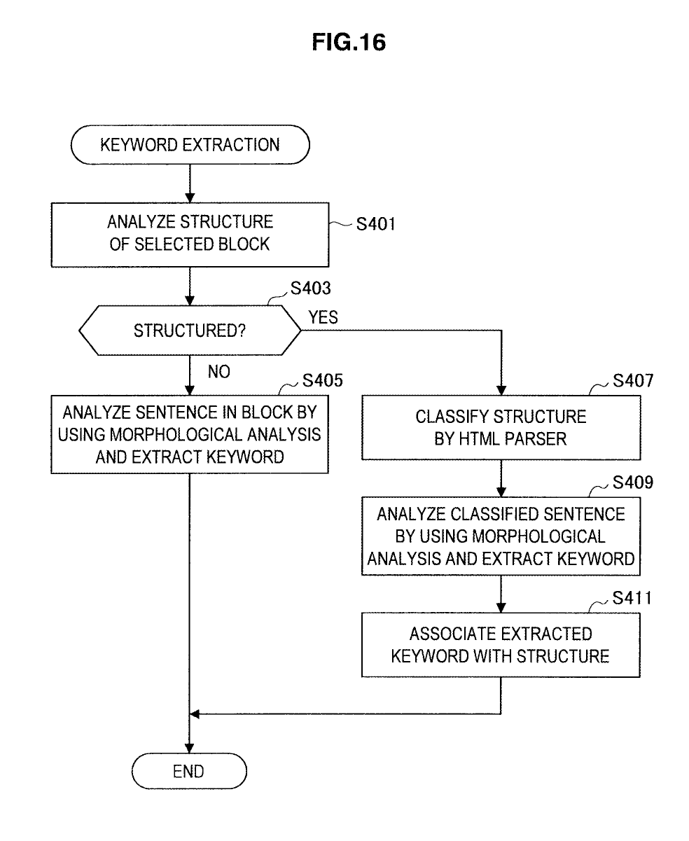

Subsequently, with reference to FIG. 16, keyword extraction processing performed by the keyword extraction section 111 will be described.

First, the keyword extraction section 111 analyzes a structure of the selected block which is specified by the selected subject determination section 109 (Step S401), and comprehends what tag is used to define a document block.

Subsequently, the keyword extraction section 111 determines, by referring to the analysis result, whether or not the selected block is written by using tags that define a specific structure, such as a list tag (i.e., whether or not it is a structured block) (Step S403).

In the case where the selected block is not structured, the keyword extraction section 111 analyzes a sentence written in the block by using morphological analysis, and extracts a keyword (Step S405).

On the other hand, in the case where the selected block is structured, the keyword extraction section 111 classifies the structure of the selected block by an HTML parser (Step S407), analyzes the classified sentence by using morphological analysis, and extracts a keyword (Step S409). Further, the keyword extraction section 111 associates the extracted keyword with the structure of the selected block (Step S411), in a manner that it is possible to comprehend which keyword is extracted from which structure.

Thus, it becomes possible for the keyword extraction section 111 to appropriately extract an appropriate keyword from the selected block.

### [Re-Layout Processing]

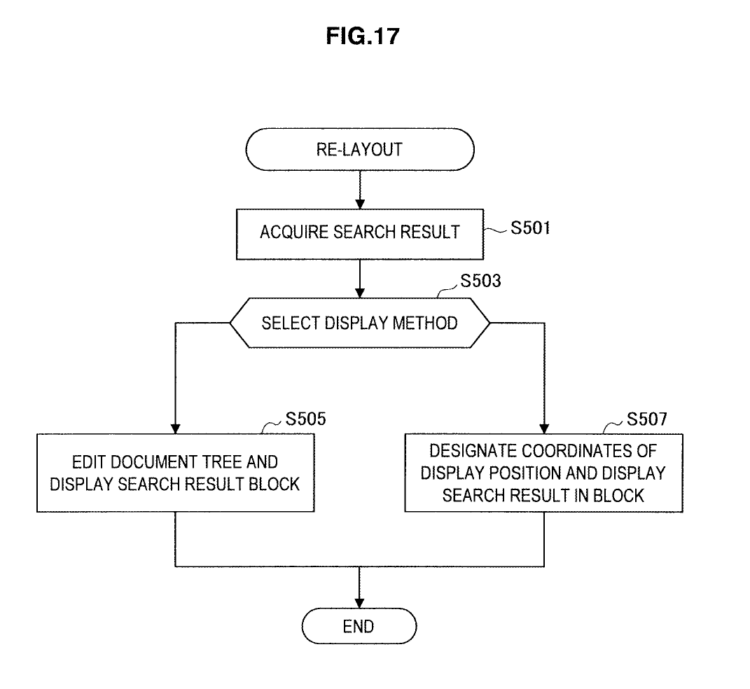

Subsequently, with reference to FIG. 17, re-layout processing performed by the application control section 101 will be described.

First, the application control section 101 acquires the search result of content and metadata associated with the content which are transmitted from the content search section 113 (Step S501). Subsequently, the application control section 101 selects a display method of a thumbnail image of the acquired image content depending on the structure of the web page, the structure of the selected block, the design of the web page, and the like (Step S503).

In the case where information related to a thumbnail image is directly and additionally written in HTML data or the like, the structure analysis section 103 of the application control section 101 edits a document tree and inserts an appropriate structural unit into a predetermined part. The layout setting section 105 performs resetting of the layout in response to new HTML data or the like, and hence, the thumbnail image of the searched content can be displayed inside the block corresponding to the extracted keyword (Step S505).

On the other hand, in the case of displaying the thumbnail image by designating coordinates of a display position, the layout setting section 105 designates, by using coordinates, a position at which the center of the thumbnail image is to be placed while referring to the position information of the document block. Thus, the thumbnail image of the searched content can be displayed inside the block corresponding to the extracted keyword (Step S507).

Heretofore, the information processing method performed by the information processing apparatus 10 according to the present embodiment has been described in detail.

### Modified Example

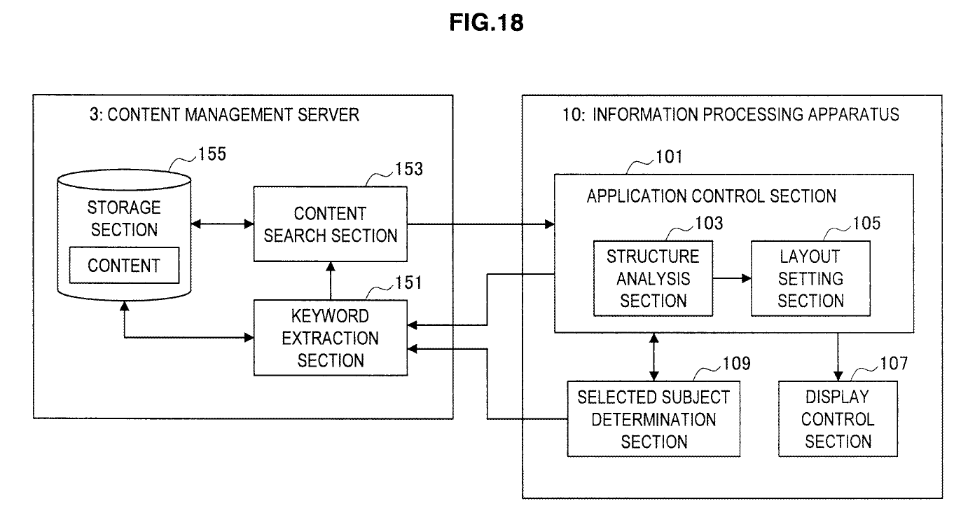

Next, with reference to FIG. 18, a modified example of the information processing apparatus 10 according to the present embodiment will be briefly described.

In the first embodiment shown above, the case has been described where the information processing apparatus 10 analyzes the structure of display control data such as HTML data and then extracts a keyword from the selected document block. However, the information processing apparatus 10 may perform the processing of analyzing the structure of the display control data and executing the determination of a selected subject, and may request the content management server 3 to perform the processing of extracting a keyword from the selected subject specified as a result of the determination.

FIG. 18 shows a part of processing sections included in an information processing apparatus 10 according to the present modified example and a part of processing sections included in a content management server 3 according to the present modified example. In the present modified example, a selected block selected by user operation is specified by an application control section 101 and a selected subject determination section 109 included in the information processing apparatus 10. After that, the information processing apparatus 10 transmits information related to the selected block to the content management server 3, and requests the content management server 3 to perform processing of extracting a keyword and processing of searching content related to the extracted keyword.

On the other hand, in the same manner as the keyword extraction section 111 of the first embodiment, a keyword extraction section 151 of the content management server 3, which has received the request, extracts a keyword from document contents corresponding to the selected block requested from the information processing apparatus 10. After that, the keyword extraction section 151 notifies a content search section 153 of the extracted keyword. The content search section 153 searches, from among various pieces of content stored in a storage section 155, content related to the notified keyword, by using metadata or the like. In succeeding in searching content, the content search section 153 notifies the information processing apparatus 10 of the detected content.

In the same manner as in the application control section 101 according to the first embodiment, the application control section 101 of the information processing apparatus 10 displays a thumbnail image in an appropriate block in response to the search result notified from the content management server 3.

As has been described above, the display position or the like of the document block included in HTML data differs depending on applications of web browsers or the like, and, eventually, depending on information processing apparatuses. Therefore, it is desired that the information processing apparatus 10 perform processing of specifying a content selected by a user by using the display position of a document displayed on the information processing apparatus 10. However, a server which manages the content is requested to perform the processing thereafter, and hence, it becomes possible to reduce the resource to be mounted on the information processing apparatus 10.

Further, in the first embodiment of the present invention, the case has been described where the selected region S selected by the user operation is a rectangle. However, the shape of the selected region S is not limited thereto, and the shape of the selected region S may be a circle or a polygon other than a quadrangle. Further, the shape of the selected region S may be a region having any shape which is designated by freehand drawing by a user using a stylus or the like. Even in those cases, it is possible to specify a selected block by using coordinate values defining the selected region S and position coordinates of a document block.

### (Hardware Configuration)

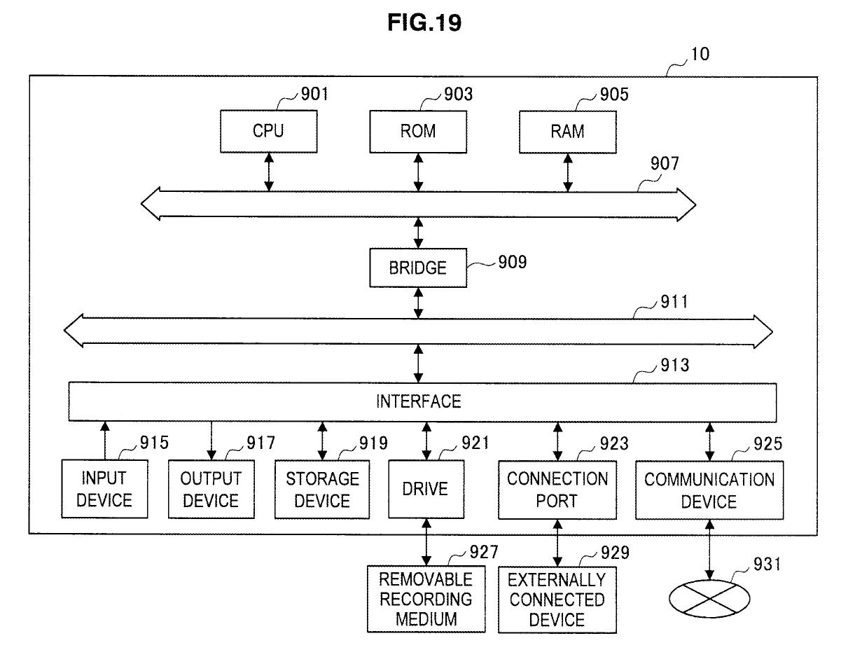

Next, the hardware configuration of the information processing apparatus 10 according to the embodiment of the present invention will be described in detail with reference to FIG. 19. FIG. 19 is a block diagram for illustrating the hardware configuration of the information processing apparatus 10 according to the embodiment of the present invention.

The information processing apparatus 10 mainly includes a CPU 901, a ROM 903, and a RAM 905. Furthermore, the information processing apparatus 10 also includes a host bus 907, a bridge 909, an external bus 911, an interface 913, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 primarily stores programs used in execution of the CPU 901 and parameters and the like varying as appropriate during the execution. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The input device 915 is an operation means operated by a user, such as a mouse, a keyboard, a touch panel, buttons, a switch and a lever. Also, the input device 915 may be a remote control means (a so-called remote control) using, for example, infrared light or other radio waves, or may be an externally connected device 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processings performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and various data obtained from the outside.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains various data from the externally connected apparatus 929 and provides various data to the externally connected apparatus 929.

The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, and satellite communication.

Heretofore, an example of the hardware configuration capable of realizing the functions of the information processing apparatus 10 according to the embodiment of the present invention has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

### SUMMARY

As has been described above, the information processing apparatus according to the embodiment of the present invention can analyze the display control data included in a web page and the like, and can automatically display a list of image content related to the information written in the block that forms data.

In this way, when a user desires to watch a video related to the written contents in a web page at the time of viewing the web page, the user can easily search image content by selecting a display content by a drag-and-drop operation.

Further, the search result is displayed in the vicinity of the block in which the keyword corresponding to the detected content is present, and hence, it becomes possible for the user to easily determine the information to which the content is related.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-264819 filed in the Japan Patent Office on Nov. 20, 2009, the entire content of which is hereby incorporated by reference.

1. An information processing apparatus comprising:
a structure analysis section to analyze display control data, in which information related to display control is written and which includes a plurality of structural units, and to extract a structural unit from the plurality of structural units included in the display control data;
a layout setting section to set layout information, which is used when displaying the display control data on a display screen, based on the structural unit extracted by the structure analysis section;
a keyword extraction section to extract a keyword from display content corresponding to the structural unit; and
a content search section to search image content corresponding to the keyword extracted by the keyword extraction section,
wherein the layout setting section places the image content searched by the content search section in a display region, in which the structural unit including the keyword corresponding to the image content is displayed.

2. The information processing apparatus according to claim 1, further comprising:
a selected subject determination section to determine a display content included in a selected region on the display screen, which is selected by user operation,
wherein the layout setting section generates position information, as the layout information, that includes coordinates indicating a position at which a display content corresponding to each structural unit is displayed on the display screen, and
wherein the selected subject determination section refers to the position information generated by the layout setting section, and, when at least a part of a region in which the display content corresponding to the structural unit is included in the selected region, determines that the structural unit is selected.

3. The information processing apparatus according to claim 2, wherein
the layout setting section sets a placement position of the image content within the display region by using coordinates indicating a position within the display screen based on the generated position information.

4. The information processing apparatus according to claim 2, wherein
the layout setting section further writes, in a corresponding structural unit, information related to the image content and information indicating a placement position of the image content within the display region.

5. The information processing apparatus according to claim 1, wherein
the keyword extraction section analyzes a type of the structural unit from which a keyword is extracted based on a type of a tag included in the structural unit, and, when the tag is a tag which defines a predetermined structure in the display screen, extracts at least one keyword from the structural unit including the tag.

6. An information processing method comprising the steps of:
analyzing display control data in which information related to display control is written and which includes a plurality of structural units, and extracting a structural unit from the plurality of structural units included in the display control data;
setting layout information which is used when displaying the display control data on a display screen based on the structural unit;
extracting a keyword from display content corresponding to the structural unit;
searching image content corresponding to the extracted keyword; and
placing the searched image content in a display region, in which the structural unit including the keyword corresponding to the image content is displayed.

7. A program for causing a computer to realize
a structure analysis function to analyze display control data in which information related to display control is written and which includes a plurality of structural units, and to extract the structural unit from the plurality of structural units included in the display control data,
a layout setting function to set layout information which is used when displaying the display control data on a display screen based on the structural unit extracted by the structure analysis function,
a keyword extraction function to extract a keyword from display content corresponding to the structural unit,
a content search function to search image content corresponding to the keyword extracted by the keyword extraction function; and
an image content placement function to place the image content searched by the content search function in a display region, in which the structural unit including the keyword corresponding to the image content is displayed.

8. An information processing system comprising:
an information processing apparatus which includes
a structure analysis section to analyze display control data in which information related to display control is written and which includes a plurality of structural units, and to extract the structural unit from the plurality of structural units included in the display control data, and
a layout setting section to set layout information which is used when displaying the display control data on a display screen based on the structural unit extracted by the structure analysis section; and
a content management server which includes:
a keyword extraction section to extract a keyword from display content corresponding to the extracted structural unit based on a extraction result of the structural unit transmitted from the information processing apparatus, and
a content search section that marches to search image content corresponding to the keyword extracted by the keyword extraction section,
wherein the layout setting section places the image content searched by the content management server in a display region, in which the structural unit including the keyword corresponding to the image content is displayed.
